(19) United States
(12) Patent Application Publication
(10) Pub. No.: US 2022/0266573 A1
(43) Pub. Date: Aug. 25, 2022

(54) LAMINATED FILM FOR BONDING AND LIGHT-TRANSMITTING LAMINATE INCLUDING SAME

(71) Applicant: SKC Co., Ltd., Suwon-si (KR)

(72) Inventors: Hyejin KIM, Suwon-si (KR); Haksoo LEE, Suwon-si (KR); Sungjin CHUNG, Seoul (KR)

(73) Assignee: SKC Co., Ltd., Suwon-si (KR)

(21) Appl. No.: 17/742,782

(22) Filed: May 12, 2022

Related U.S. Application Data
(63) Continuation of application No. PCT/KR2020/014334, filed on Oct. 20, 2020.

(30) Foreign Application Priority Data
Nov. 13, 2019 (KR) 10-2019-0145154

(51) Int. Cl. B32B 17/10; C09J 7/00

(52) U.S. Cl. CPC B32B 17/10587; B32B 17/10761; C09J 7/00; B32B 2605/006; C09J 2301/206; C09J 2301/312

(57) ABSTRACT

A film for laminating including an embossed surface, wherein the embossed surface includes a plurality of convex parts and a plurality of concave parts disposed between the plurality of convex parts, wherein each of the plurality of convex parts is surrounded by the plurality of concave parts and does not include a convex part, wherein each of the plurality of convex parts has an average area of 4.0 mm² or less, wherein an absolute value of Skewness (Ssk) of the embossed surface is more than 0, and 1 or less, and wherein Ar of the embossed surface is 1.001 to 2, where Ar is calculated by the following Formula 1:

$$Ar = \frac{As}{Ac} \qquad [ Formula 1 ]$$

where, in the Formula 1, As is an average surface area of surface profiles of the plurality of convex parts comprised in a unit area (1 cm²) of the embossed surface and Ac is an average area occupied by the plurality of convex parts comprised in a unit area (1 cm²) of the embossed surface, is disclosed.

### CROSS-REFERENCE TO RELATED APPLICATIONS

Pursuant to 35 USC 120 and 365(c), this application is a continuation of International Application No. PCT/KR2020/014334 filed on Oct. 20, 2020, and claims the benefit under 35 USC 119(a) of Korean Application No. 10-2019-0145154 filed on Nov. 13, 2019 in the Korean Intellectual Property Office, the entire disclosures of which are incorporated herein by reference for all purposes.

### BACKGROUND

### 1. Field

The present disclosure relates to a film for laminating, and a light transmitting laminate including the same.

### 2. Description of the Background

Polyvinyl acetal is being used as an interlayer (film for laminated glass) of a laminated glass (safety glass) or a light transmitting laminate. Laminated glass is mainly used in windows of architecture, cladding, and window glass of automobiles. Due to characteristics such as anti-scattering of glass fragments and penetration resistance against impact of a certain strength, laminated glass can secure stability for minimizing damage or injury given to objects or people located inside the architecture or the automobiles.

A film for laminating has plural minute embossments formed on its surface to improve workability such as preventing blocking among interlayers, overlapping a glass plate with an interlayer (sliding property from a glass plate as handling workability), and deairing a film when processed to be laminated with a glass plate.

When a film for laminating, in which embossments are formed, is used for lamination, there is a possibility of generating an interference fringe or a bubble due to the embossments placed on both surfaces of the film, and a visibility may be lowered. Also, the workability may be degraded when a dazzle occurs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a film for laminating includes an embossed surface, wherein the embossed surface may include a plurality of convex parts and a plurality of concave parts disposed between the plurality of convex parts, wherein each of the plurality of convex parts may be surrounded by the plurality of concave parts and may not include a convex part, wherein each of the plurality of convex parts may have an average area of 4.0 mm² or less, and wherein an absolute value of Skewness (Ssk) of the embossed surface may be more than 0, and 1 or less.

An average area of the plurality of concave parts per unit area of 1 cm² may be 0.5 mm² or less.

The film for laminating may have a variance of vacuum degree of 0 to 25 mmHg when, after light transmitting bodies are laminated on both surfaces thereof, vacuumizing is performed at room temperature and a temperature of the film for laminating is increased by 10° C.

The embossed surface may include a plurality of peak portions and a plurality of valley portions.

The plurality of peak portions and the plurality of valley portions may be asymmetrically distributed.

The embossed surface may have a ten-point height of irregularities (Sz) of 30 to 90 μm.

At least one of the plurality of convex parts may be enclosed by a closed curve formed by the at least one of the plurality of convex parts and the plurality of concave parts.

The film for laminating may include a plurality of convex parts and a plurality of concave parts disposed between the plurality of convex parts disposed on at least some or all of another surface opposite to the embossed surface.

Shapes of the plurality of convex parts included in a unit area (1 cm²) of the embossed surface may be different from shapes of the plurality of convex parts included in a unit area of the another surface.

The embossed surface may include 90 to 9,800 convex parts per unit area (1 cm²).

The embossed surface may include a minute pattern.

Ar of the embossed surface may be 1.001 to 2, where Ar is calculated by the following Formula 1:

$$Ar = \frac{As}{Ac} \qquad [ Formula 1 ]$$

where, in the Formula 1, As is an average surface area of surface profiles of the plurality of convex parts included in a unit area (1 cm²) of the embossed surface and Ac is an average area occupied by the plurality of convex parts included in a unit area (1 cm²) of the embossed surface.

Each of the plurality of convex parts surrounded by the plurality of concave parts may be adjacent to three to seven convex parts, which share some of the plurality of concave parts.

The plurality of convex parts may be different in shape.

The film for laminating may be a single layer or a laminated film of two or more layers.

The film for laminating may include a polyvinyl acetal resin.

The film for laminating may include a wedge shape in at least some or all of a cross-section thereof.

In another general aspect, a light transmitting laminate includes a first light transmitting layer, a film for laminating disposed on one surface of the first light transmitting layer, and a second light transmitting layer disposed on the film for laminating, wherein the film for laminating may include an embossed surface, wherein the embossed surface may include a plurality of convex parts and a plurality of concave parts disposed between plurality of convex parts, wherein the plurality of convex parts may be surrounded by the plurality of concave parts and may not include a concave part, wherein each of the plurality of convex parts may have an average area of 4.0 mm² or less, and wherein an absolute value of Skewness (Ssk) of the embossed surface may be more than 0, and 1 or less.

In another general aspect, a vehicle may include the light transmitting laminate as a windshield.

Other features and aspects will be apparent from the following detailed description and the claims.

### BRIEF DESCRIPTION OF THE DRAWINGS

FIG. 1 is a conceptual view for illustrating the embossed surface of the film for laminating manufactured according to one embodiment.

FIG. 2 is a conceptual view for showing a portion of the cross-section of the film for laminating manufactured according to another embodiment in a pre-laminated state of being disposed between a pair of glasses.

FIG. 3 is a conceptual view for illustrating a portion of the embossment pattern of the embossment transferring device applied in another embodiment.

FIG. 4 and FIG. 5 are conceptual views for illustrating cross-sections of embossments of the film for laminating manufactured according to another embodiment, respectively.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

In this disclosure, the term for degree like “about”, “substantially” and the like is used for meaning values approximative from/to the value when a tolerance to be proper to referred meaning for manufacture and substance is presented. Additionally, these terms for degree are used to help understanding of example embodiments and to prevent that an unconscionable trespasser unjustly uses the presented content in which exact or absolute number is referred.

Throughout this disclosure, the phrase “combination(s) thereof” included in a Markush-type expression denotes one or more mixtures or combinations selected from the group consisting of components stated in the Markush-type expression, that is, denotes one or more components selected from the group consisting of the components are included.

Throughout this disclosure, the description of “A and/or B” means “A, B, or A and B.”

Throughout this disclosure, terms such as “first”, “second”, “A”, or “B” are used to distinguish the same terms from each other unless specially stated otherwise.

In this disclosure, “B being placed on A” means that B is placed in direct contact with A or placed over A with another layer or structure interposed therebetween and thus should not be interpreted as being limited to B being placed in direct contact with A.

In this disclosure, a singular form is contextually interpreted as including a plural form as well as a singular form unless specially stated otherwise.

In the present disclosure, the polygon refers to a figure of two dimension having three or more sides, and includes triangle, tetragon, pentagon, hexagon, and so on. Additionally, polygons including one or more curves in some or the whole thereof like circle and ellipse that have infinite sides are also included.

In the present disclosure, the amount of a hydroxyl group was evaluated by measuring an amount of ethylene group combined with the hydroxyl group of the polyvinyl acetal resin by a method in accordance with JIS K6728.

In the present disclosure, room temperature is 20 to 25° C., and specifically 25° C.

A1 (Peak cross-sectional area), Ssk (Skewness), Sk (Core height), Smr1 (Peak material portion), Spk (Reduced peak height), and Sz (Ten point height of irregularities) values are values evaluated according to ISO_25178, and measurable by a 3D roughness meter.

Areal material ratio curve, also called as Abbott-Firestone curve, is a curve illustrated by mathematically converting a surface profile height of an object to a cumulative probability density function, and it is one method among methods for showing surface characteristics of an object.

Areal material ratio curve uses an equivalent straight line. The equivalent straight line is a line including 40% of measuring points of the curve, and refers to a line, which has the minimum gradient, when a zone of 40% within a total zone of areal material ratio is arbitrarily designated from the curve and both end points of the designated zone are connected. Through the equivalent straight line, the values showing surface characteristics such as A1, Sk, Smr1, Spk, and the like can be evaluated.

A surface embossment characteristic may be given to a film for laminating to prevent unnecessary blocking between surfaces thereof when the film for laminating is winded, and to give deairing property to the film when the film is laminated with a light transmitting laminate such as a glass plate. Additionally, optical distortion, which may occur when the film is laminated with a light transmitting laminate, can be decreased, and formation of roughness in a certain range and functionality can be easily obtained by the surface embossment characteristic.

When a pattern, of which a surface profile height having a relatively high symmetry is formed on a surface of a film for laminating, deairing property of the film for laminating can be improved, and occurrence of defects such as bubbles after laminating with glass or the like can be effectively prevented.

However, if only the deairing property of the film for laminating is emphasized, optical properties or an edge sealing characteristic may be deficient, and if the edge sealing characteristic is emphasized, optical properties may be degraded instead due to problems such as the occurrence of bubbles.

Furthermore, a film for laminating may have different convenience and accuracy for a foreign body inspection depending on the surface characteristics. When a pattern, of which the surface profile height has a high regularity is formed on a surface of the film for laminating with a high light transmittance, a moire pattern may be observed due to light diffraction, which occurs from patterns formed on both surfaces of the film.

The moire pattern causes lowering of workability because it may make eyes of a worker to be tired in a process for observing foreign body mingled inside the film for laminating by naked eyes during a preparing process for laminating or before the laminating. That is, the moire pattern may degrade visibility of the film for laminating and thereby may deteriorate convenience, accuracy, and the like of a foreign body inspection.

The inventors have found that, when characteristics of embossments on a surface pattern of a film for laminating were adjusted, the film for laminating can prevent occurrence of a moire pattern on the surface with having stable deairing property and edge sealing characteristic.

Therefore, the objective of the present disclosure is to provide a film for laminating, which inhibits occurrence of a moire pattern while having stable deairing property, and a light transmitting laminate including the same.

The film for laminating and the light transmitting laminate including the same of example embodiments includes controlled characteristics of an embossed surface and thereby can provide the film for laminating having stable deairing property and preventing occurrence of a moire pattern.

Hereinafter, example embodiments will be described in further detail.

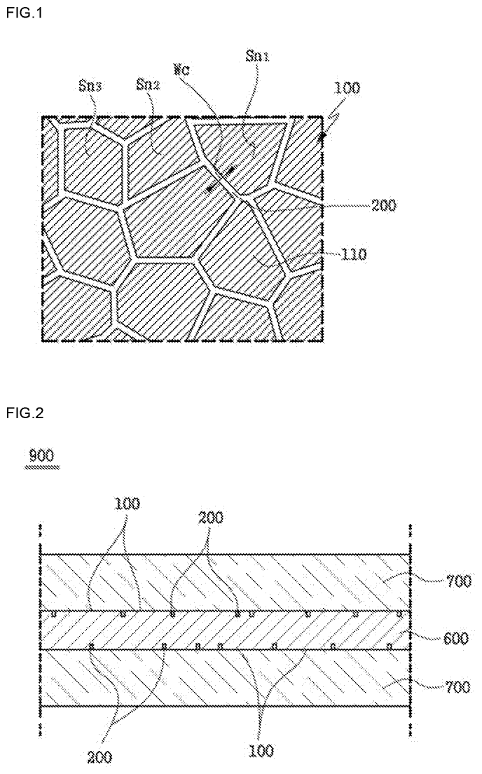

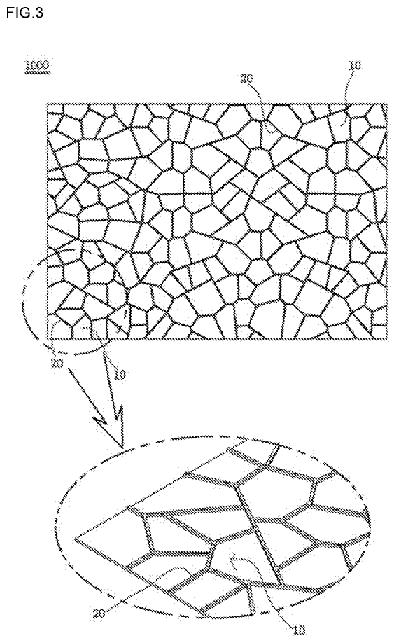

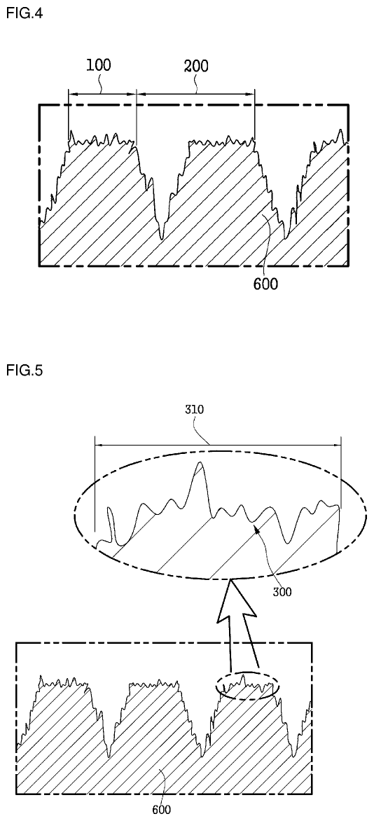

FIG. 1 is a conceptual view for illustrating the embossed surface of the film for laminating manufactured according to one embodiment, FIG. 2 is a conceptual view for showing a portion of the cross-section of the film for laminating manufactured according to another embodiment in a pre-laminated state of being disposed between a pair of glasses, FIG. 3 is a conceptual view for illustrating a portion of the embossment pattern of the embossment transferring device applied in another embodiment, and FIG. 4 and FIG. 5 are conceptual views for illustrating cross-sections of embossments of the film for laminating manufactured according to another embodiment, respectively. With reference to the FIGS. 1 to 5, below example embodiments are described in detail.

For achieving the above objective, the film for laminating 600 according to one embodiment in the present disclosure includes an embossed surface, and the embossed surface includes a plurality of convex parts 100, and a plurality of concave parts 200 disposed between the plurality of convex parts 100.

The convex parts 100 are portions contacting with a light transmitting laminate within the embossed surface when the film for laminating is stacked with a light transmitting laminate before being laminated with the light transmitting laminate.

The concave parts 200 are remaining portions except the convex parts 100 within the embossed surface of the film for laminating before being laminated.

The convex parts 100 are surrounded by the concave parts 200 and do not include concave parts 200 inside the convex parts 100.

The convex parts 100 have an average area of 4.0 mm² or less, and the embossed surface has an absolute value of Ssk of more than 0, and 1 or less.

At least one of the plurality of convex parts may be enclosed by a closed curve formed by the at least one of the plurality of convex parts and the plurality of concave parts. For example, in the first convex part 110 surrounded by the concave parts 200, a line where the first convex part 110 and the concave parts 200 meet, may make a simple closed curve.

The first convex part 110 surrounded by the concave parts 200 may have a line in the shape of a polygon, which connects portions where the first convex part 110 and the concave parts 200 meet.

The polygon may be a triangle, a quadrangle, a pentagon, a hexagon, a heptagon, or an octagon, and a mixture thereof. The polygon refers to a shape of a polygon substantially, and a line, where concave parts 200 and the first convex part 110 meet may not be necessarily a straight line and a portion shown as a curve may be present in some part thereof, because the embossment pattern is formed by pressurizing an embossment transferring device such as a mold or a roller on the film.

An angle at a vertex of the polygon may be 40° or more, and less than 180°.

The angle at the vertex refers to an angle at a point, where lines connecting between convex parts 100 and concave parts 200 neighboring to one another meet each other, and specifically the angle may be 45° to 160°.

Each of the convex parts 100 has an average area of 4.00 mm² or less.

The average area of the convex parts is evaluated by measuring an average area of each of the convex parts per a unit area (1 cm²) of the embossed surface within the film for laminated glass 600.

Specifically, the average area of each of the convex part 100 may be 2 mm² or less.

The average area may be 0.5 mm² or less. The average area may be 0.4 mm² or less. The average area may be 0.01 mm² or more. The average area may be 0.02 mm² or more. The average area may be 0.05 mm² or more. In such a case, concave parts that function as a passage for emitting air are formed in the embossed surface with a sufficient density and a film for laminating can have stable deairing property.

In further detail, the embossed surface of the film for laminated glass 600 may be a small area type, of which the average area of each of the convex part 100 is 0.1 mm² to 0.5 mm², may be a middle area type, of which the average area of each of the convex part 100 is more than 0.5 mm² and 0.9 mm² or less, may be a large area type, of which the average area of each of the convex part 100 is more than 0.9 mm² and 1.5 mm² or less, or may be a super large area type, of which the average area of each of the convex part 100 is more than 1.5 mm² and 4.00 mm² or less.

80% or more of the convex parts 100 among the convex parts included in a unit area (1 cm²) of the embossed surface may have an area satisfying below Formula 2, respectively:

$$0.4 \times Sm \leq Sni < 1. \times Sm or 1. \times Sm < Sni \leq 1.6 \times Sm \qquad [ Formula 2 ]$$

where, in the Formula 2, Sni is an area of the convex parts 100, Sm is an average area of each of the convex parts measured from a unit area (1 cm²) of the embossed surface.

Specifically, 90% or more of the convex parts 100 among the convex parts included in a unit area (1 cm²) of the embossed surface may satisfy the Formula 2, respectively.

The film for laminating 600 having an embossed surface, which has such an area condition of convex parts, may have convex parts 100 having different shape and/or area from one another and may be located with having concave parts 200 therebetween, wherein overall sizes of these convex parts are maintained within a certain range and simultaneously embossments having an irregular shape are obtained. Through this, the film for laminating can have excellent deairing property without an occurrence of an interference fringe of light diffraction even though the embossments are overlapped.

The embossed surface may have a standard deviation of the area of convex parts located within a unit area (1 cm²), which is 0.01 to 0.4, or 0.05 to 0.35.

When the convex parts 100 are a small area type, the standard deviation of the area of convex parts may be 0.01 to 0.1, when the convex parts 100 are a middle area type, the standard deviation of the area of convex parts may be 0.1 to 0.2, and when the convex parts 100 are a large area type or a super large area type, the standard deviation of the area of convex parts may be 0.2 to 0.3. When the standard deviation of an area of convex parts is in such a range, convex parts 100 with comparatively even sizes can be disposed in the embossed surface as an irregular pattern overall.

The embossed surface includes plurality of convex parts 100 and concave parts 200 surrounding the plurality of convex parts 100 and being connected from one another, the average area of the convex parts 100 may be 4 mm² or less, and the average area per unit area (1 cm²) of the concave parts 200 may be 0.5 mm² or less.

Specifically, the average area of concave parts 10 per unit area (1 cm²) may be 0.4 mm² or less. The average area per unit area (1 cm²) may be 0.3 mm² or less. The average area per unit area (1 cm²) may be 0.01 mm² or more. The average area per unit area (1 cm²) may be 0.02 mm² or more.

The height difference between convex parts 100 and concave parts 200 may be 80 μm or less. The height difference may be 70 μm or less. The height difference may be 60 μm or less. The height difference may be 3 to 55 μm. The height difference may be 5 to 45 μm. In such a case, the film for laminating has a sufficient height difference on the embossed surface, the embossments are maintained rather than disappearing totally even in a pre-laminating process among subsequent laminating processes, and the film can have sufficient deairing property.

A width Wc of concave parts 200 may be 2 to 120 μm.

A sectional shape of concave parts 200 may be mostly quadrangle, half-circle, inverted triangle, lozenge, or the like, and the shape is not specially limited thereto, if the shape is concave.

The width Wc of concave parts refers to a width of concave parts in a virtual surface extended from the convex parts 100.

A film for laminating includes a starting point and an ending point, wherein the starting point is any one point where one end of the surface embossment shape contacts with concave parts, and the ending point is a point where one end of the surface embossment shape contacts with concave parts and any one point which is the same as or different from the starting point.

The concave parts may have at least two or more vertices from a line connecting the starting point and the ending point. An angle between two concave parts meeting at the vertex may be more than 90 and less than 270, or more than 0 and less than 90. The angle between concave part and concave part meeting at the vertex may be 100 to 260 degrees or 10 to 80 degrees.

The concave parts 200 function as a passage, through which air passes in a laminating process, and some of the concave parts are maintained rather than disappearing totally even after pre-laminating thereby allowing a film for laminating to have excellent deairing property. Additionally, the width of concave parts 200 is formed to have a value within a certain range overall, but the shape does not have a regular pattern and thereby a film for laminating also having excellent optical properties can be manufactured.

An absolute value of Ssk of the embossed surface is more than 0, and 1 or less.

The Ssk value is a value evaluated according to ISO_25178. A measured and calculated value of the Ssk value can be obtained by using a three-dimensional roughness meter, and for example, 3D roughness can be measured and obtained by using Contour GT model of 3D Optical Microscopy available from BRUKER at VSI (Vertical scanning Interferometry) Mode.

As a method for controlling the Ssk value of the embossed surface, a method of controlling a shape and arrangement of a pattern on a surface of a film for laminating, a method of adding additional processing of a minute pattern on a film for laminating, a method of applying a melt fracture process and the like may be applicable, but the method is not limited thereto.

The absolute value of Ssk of the embossed surface may be more than 0. The absolute value of Ssk may be 0.05 or more. The absolute value of Ssk may be 0.1 or more.

The absolute value of Ssk may be 1 or less. The absolute value of Ssk may be 0.9 or less. The absolute value of Ssk may be 0.8 or less. In such a case, a film for laminating can have stable deairing property when being laminated with a light transmitting laminate.

The film for laminating can control both of the average area of convex parts and the Ssk value on the embossed surface. When the average area of convex parts of the embossed surface is controlled and the embossments have an irregular shape, it is possible to inhibit a diffraction phenomenon occurring between patterns of the embossed surface, and residual air can be emitted through concave parts formed on the embossed surface during laminating of the film for laminating and the light transmitting laminate. At the same time, the Ssk value of an embossed surface is controlled and thereby a bubble, which can be formed between convex parts and a light transmitting laminate when a film for laminating is stacked with a light transmitting laminate, can be inhibited.

An A1 value of the embossed surface is 0.12 or less.

The A1 value is evaluated according to ISO_25178.

The A1 value can be obtained from areal material ratio curve. A measured and calculated value of the A1 value can be obtained by using a three-dimensional roughness meter.

A measurement of 3D roughness may be evaluated by an average value of values measured in a total area of 1,000,000 μm² or more. In detail, when measured by using a three-dimensional optical profiler or a 3D laser measuring microscope, the 3D roughness may be respectively measured five times or more in positions different from one another, and an average of values except for the maximum and the minimum values can be used as a measuring value for three-dimensional roughness. When using a 3D laser measuring microscope, 3D roughness can be measured by utilizing STICHING function to join images in neighboring positions from one another, and the measurement of 3D roughness utilizing this STICHING function can also be evaluated by the average of values measured in a total area of 1,000,000 μm² or more.

For example, the 3D roughness can be obtained by using Contour GT model of 3D Optical Microscopy available from BRUKER and measuring 3D roughness at VSI (Vertical scanning Interferometry) Mode.

The A1 value of an embossed surface may be 0.12 or less. The A1 value may be 0.1 or less. The A1 value may be 0.09 or less. The A1 value may be more than 0. The A1 value may be 0.01 or more. The A1 value may be 0.02 or more. In such a case, convex parts of the embossed surface can be controlled to be maintained within a certain volume range, and the film for laminating can have stable deairing property and edge sealing characteristic.

The film for laminating can control both of A1 value and Ssk value on the embossed surface. When a mold or a roller for transferring a pattern on the surface of the film for laminating is excessively processed, the Ssk value may be excessively high. In this case, a moire pattern may not occur on a surface of the film for laminating, but edge sealing characteristic or deairing property of the film for laminating may be degraded. When both of A1 value and Ssk value of the embossed surface are controlled, the film for laminating can have stable edge sealing characteristic and deairing property with excellent optical properties.

The film for laminating may have a vacuum variance of 0 to 25 mmHg when light transmitting bodies are stacked on both surfaces of the films and vacuumized at room temperature, and after that, the temperature is increased by 10° C.

A detailed measuring method of a vacuum variance of the film for laminating is described in below experimental examples, and thus the further description is omitted to avoid overlapped description.

In a case of a film for laminating having excellent deairing property, when stacked with a light transmitting laminate and vacuumized, air between the film for laminating and the light transmitting laminate is sufficiently emitted and residual air may not exist or exist in a trace amount. This makes a formation of a light transmitting laminate having more clear and excellent optical properties after main laminating. Accordingly, when a pattern on a surface is rapidly collapsed upon applying a vacuum, an amount of the emitted air is slight, and the variance of vacuum degree becomes small.

The variance of vacuum degree of a film for laminating may be 0 mmHg or more. The variance of vacuum degree may be 5 mmHg or more. The variance of vacuum degree may be 7 mmHg or more. The variance of vacuum degree may be 40 mmHg or less. The variance of vacuum degree may be 25 mmHg or less. The variance of vacuum degree may be 10 mmHg or less. In such a case, the film for laminating can have comparatively stable deairing property even when applying a laminating process at a low temperature as well as when applying an ordinary laminating process.

The embossed surface includes peak portions and valley portions. A pattern located above the average surface height of the embossed surface is referred to as peak portions, and a pattern located under the average surface height is referred to as valley portions.

The present disclosure provides the film having features such as controlled embossment characteristics to allow the peak portions and the valley portions to be substantially asymmetrically distributed, and thereby can provide the film, of which an optical interference phenomenon is substantially inhibited while deairing performance is excellently maintained. The surface of the film for laminating may be controlled to have a volume of peak portions, which is larger than a volume of valley portions. The surface of the film for laminating may be controlled to have a volume of valley portions, which is larger than a volume of peak portions.

The Sz value of the embossed surface may be 30 to 90 μm.

The Sz value may be evaluated according to ISO_25178.

A measured and calculated value of the Sz value can be obtained by using a three-dimensional roughness meter, and for example, Contour GT model of 3D Optical Microscopy available from BRUKER may be used to measure 3D roughness at VSI (Vertical scanning Interferometry) Mode.

The Sz value of the embossed surface may be 30 μm or more. The Sz value may be 40 μm or more. The Sz value may be 45 μm or more. The Sz value may be 90 μm or less. The Sz value may be 80 μm or less. The Sz value may be 75 μm or less. The film for laminating having such a surface embossment characteristic can have stable deairing property.

The film for laminating includes plurality of convex parts disposed on at least some or the whole of the other surface, and concave parts disposed between the convex parts neighboring to one another.

At this time, the shape of convex parts included in a unit area (1 cm²) of one surface of the film for laminating 600 may be different from the shape of convex parts disposed in a unit area of the other surface of the film for laminating 600, which is opposite to the one surface.

In this manner, the film for laminating 600 may have different shapes of convex parts 100 on the opposite surfaces of one surface and the other surface and having no regularity, thus occurrence of diffraction interference fringes is prevented thereby achieving excellent optical properties.

In addition, the film for laminating 600 has excellent deairing performance as well as excellent edge sealing performance by the concave parts connected from one another directly or indirectly and disposed between the convex parts.

The embossed surface may include 24 to 9,800 convex parts 100 per unit area (1 cm²).

The embossed surface of the film for laminating may include a minute pattern.

The minute pattern is a smaller sized pattern than a pattern before the minute pattern is formed. The minute pattern may be formed on the surface of the embossments, or may be formed on the surface of the film, on which embossments are not formed.

In a process of forming embossments, a method of additional processing of a minute pattern on one surface of the film for laminating or a method of additional processing of a minute pattern on the surface of a mold or a roller for forming the embossments may be applied, and thereby additional randomness can be achieved on the embossed surface. In such a case, the film for laminating can have characteristics described above and can inhibit an interference phenomenon occurring among embossments.

In detail, the minute pattern may be additionally processed by additional processing on a mold or a roller for transferring embossments to the film for laminating, and thereby transferring a pattern to the film for laminating with the mold or the roller. For example, minute sand blast treatment may be added to the mold or the roller and thereby a minute pattern can be additionally processed. However, a method of additional processing of a minute pattern is not limited thereto.

The film for laminating may have an Ar value of 1.001 to 2 in the embossed surface. The Ar value is expressed by Formula 1 below.

$$Ar = \frac{As}{Ac} \qquad [ Formula 1 ]$$

In the Formula 1, As is an average surface area of a surface profile of the convex parts included in a unit area (1 cm²) of the embossed surface, and the Ac is an average area occupied by convex parts included in a unit area (1 cm²) of the embossed surface.

The Ar value of the embossed surface may be 1.001 or more. The Ar value may be 1.1 or more. The Ar value may be 1.2 or more. The Ar value may be 2 or less. The Ar value may be 1.6 or less. The Ar value may be 1.4 or less. In such a case, the embossments form an irregular pattern and can prevent a decline of visibility resulting from interaction of light among patterns.

As a method of controlling Ar value, a method of controlling a shape of embossments, a method or giving an additional minute pattern on the embossed surface, or the like may be applied, but the method is not limited thereto.

The first convex part 110 located inside the embossed surface, and surrounded by the concave parts 200, while not including concave parts in the inside thereof, may neighbor to three to seven adjacent convex parts sharing some of concave parts 200.

At this time, the first convex part 110 and adjacent convex parts may be different in a shape or area. When the first convex part 110 and the adjacent convex parts are different in the shape or the like in this manner, an irregular shaped embossment pattern having a polygonal size within a certain range and being not identical from one another can be formed.

The film for laminating may be a single layer film or a multilayer film.

When the film for laminating is a single layer film, the film for laminating may include an adhesive layer.

Hereinafter, the composition of the film for laminating or the like will be described.

A film for laminating may include a polyvinyl acetal resin, or may include a polyvinyl acetal resin and a plasticizer.

In detail, the film for laminating may include a polyvinyl acetal resin in an amount of 60 wt % to 76 wt %. The film for laminating may include a polyvinyl acetal resin in an amount of 70 wt % to 76 wt %. The film for laminating may include a polyvinyl acetal resin in an amount of 71 wt % to 74 wt %. When a polyvinyl acetal resin is included in such a range, comparatively high tensile strength and modulus can be granted to the film for laminating.

The polyvinyl acetal resin may have an acetyl group in an amount of less than 2 wt %. The polyvinyl acetal resin may have an acetyl group in an amount of 0.01 or more and less than 1.5 wt %. The polyvinyl acetal resin may have a hydroxyl group in an amount of 15 wt % or more. The polyvinyl acetal resin may have a hydroxyl group in an amount of 16 wt % or more. The polyvinyl acetal resin may have a hydroxyl group in an amount of 19 wt % or more. Also, the polyvinyl acetal resin may have a hydroxyl group in an amount of 30 wt % or less. When a polyvinyl acetal resin having an hydroxyl group in such amount is applied to the film for laminating, it is possible to have mechanical properties such as proper penetration resistance in addition to being excellently laminated with a material such as glass.

The polyvinyl acetal resin may be a polyvinyl acetal resin obtained by acetalization of a polyvinyl alcohol having a polymerization degree of 1,600 to 3,000 with aldehyde, or may be a polyvinyl acetal resin obtained by acetalization of a polyvinyl alcohol having a polymerization degree of 1,700 to 2,500 with aldehyde. When such polyvinyl acetal is applied, mechanical properties like penetration resistance can be sufficiently improved.

The polyvinyl acetal resin may be one synthesized from polyvinyl alcohol and aldehyde, and the aldehyde is not limited in type. In detail, the aldehyde may be any one selected from the group consisting of n-butyl aldehyde, isobutyl aldehyde, n-valer aldehyde, 2-ethyl butyl aldehyde, n-hexyl aldehyde, and blend resins thereof. When n-butyl aldehyde is applied as the aldehyde, the resulting polyvinyl acetal resin may have a refractive index with little difference from glass, and excellent adhesion property with glass and the like.

The film for laminating may include a plasticizer in an amount of 24 to 40 wt %. The film for laminating may include a plasticizer in an amount of 24 to 30 wt %. The film for laminating may include a plasticizer in an amount of 26 to 29 wt %. A case including a plasticizer in such range is preferable in that the laminated film for laminating can achieve a proper adhesive strength and impact resistance.

In detail, the plasticizer may be any one selected from the group consisting of triethylene glycol bis 2-ethylhexanoate (3G8), tetraethylene glycol diheptanoate (4G7), triethylene glycol bis 2-ethylbutyrate (3GH), triethylene glycol bis 2-heptanoate (3G7), dibutoxyethoxyethyl adipate (DBEA), butyl carbitol adipate (DBEEA), dibutyl sebacate (DBS), bis 2-hexyl adipate (DHA) and combinations thereof. Specifically, any one selected from the group consisting of triethylene glycol di-2-ethyl butyrate, triethylene glycol di-2-ethylhexanoate, triethylene glycol di-n-heptanoate, and combinations thereof may be included as the plasticizer, and further specifically, triethylene glycol bis 2-ethylhexanoate (3G8) may be included.

The film for laminating may further include an additive as needed, and for example, the additive may be any one selected from the group consisting of an antioxidant, a heat stabilizer, a UV absorber, a UV stabilizer, an IR absorber, a glass adhesion regulator, and combinations thereof.

As the antioxidant, a hindered amine-based antioxidant or a hindered phenol-based antioxidant may be used. Specifically, on a process of manufacturing polyvinyl butyral (PVB), which needs a processing temperature of 150° C. or higher, a hindered phenol-based antioxidant is further preferable. The hindered phenol-based antioxidant may be for example, IRGANOX 1076, 1010, or so on available from BASF SE.

As the heat stabilizer, a phosphite-based heat stabilizer may be used considering suitability with an antioxidant. For example, the heat stabilizer may be IRGAFOS 168 available from BASF SE.

As the UV absorber, Chemisorb 12, Chemisorb 79, Chemisorb 74, or Chemisorb 102 available from CHEMIPRO KASEI KAISHA, LTD may be used, or Tinuvin 328, Tinuvin 329, or Tinuvin 326 available from BASF SE may be used. As the UV stabilizer, Tinuvin available from BASF SE may be used. As the IR absorber, ITO, ATO, or AZO may be used, and as the glass adhesion regulator, a metal salt such as magnesium (Mg), potassium (K), sodium (Na), epoxy-based modified silicon (Si) oil, or a mixture thereof may be used, but the present disclosure is not limited thereto.

The film for laminating may be a multilayer film. The film for laminating may be a laminate with two or more layers, a laminate with three or more layers, or a laminate with five or more layers. The multilayer film may include an adhesive layer in direct contact with a light transmitting laminate such as a glass plate and a core layer distinct from the adhesive layer. The core layer may include functionality, and for example, may have functionality such as heat insulating functionality.

The multilayer film may have at least one layer including a polyvinyl acetal resin corresponding to a composition of the single layer described above, or including a polyvinyl acetal resin and a plasticizer. Descriptions of the polyvinyl acetal resin and the plasticizer are overlapped with the above description and thus the further description is omitted.

The film for laminating may include a sound insulating layer. The sound insulating layer may be disposed between adhesive layers, or may be disposed on one surface of an adhesive layer.

The sound insulating layer may include a polyvinyl acetal resin.

The sound insulating layer may include a polyvinyl acetal resin in an amount of 54 wt % or more. The sound insulating layer may include a polyvinyl acetal resin in an amount of 76 wt % or less. The sound insulating layer may include a polyvinyl acetal resin in an amount of 60 wt % or more. The sound insulating layer may include a polyvinyl acetal resin in an amount of 70 wt % or less.

The sound insulating layer may include a plasticizer in an amount of 24 wt % or more. The sound insulating layer may include a plasticizer in an amount of 6 wt % or less. The sound insulating layer may include a plasticizer in an amount of 30 wt % or more. The sound insulating layer may include a plasticizer in an amount of 40 wt % or less.

A polyvinyl acetal resin included in the sound insulating layer may have an acetyl group in an amount of 8 mol % or more. The polyvinyl acetal resin may have an acetal group of 8 mol % to 30 mol %. Also, a polyvinyl acetal resin included in the sound insulating layer may have a hydroxyl group in an amount of 26 mol % or less. The polyvinyl acetal resin may have a hydroxyl group in an amount of 10 wt % to 25 wt %. In such a case, it is possible to render more stable sound insulating characteristic to the film for laminating.

The film for laminating may be manufactured to be a sheet form by extruding a composition for manufacturing the film for laminating including a resin and a plasticizer, and an additive as needed, and shaping it through a T-DIE or the like. When the film for laminating is a multilayer film, a laminating mean such as a feed block may be further applied to a front of the T-DIE.

The film for laminating manufactured into a sheet form may be manufactured by processes such as controlling of a thickness and forming of embossments, but a manufacturing method for the film for laminating in embodiments is not limited thereto.

A single layer film or a multilayer film is manufactured into a sheet form by the same method described above, and after that, a mold or a roller is applied to form surface embossments of the film and manufacture the film for laminating.

The surface characteristics of the mold or the roller are complementarily transferred to the film surface, and therefore the characteristics of the embossed surface can be controlled by controlling the surface characteristics of the mold or the roller.

The film for laminating may be a film for laminating having a head up display functionality and a wedge shape in at least some or the whole section thereof. The film for laminating may have a wedge shape, whose section has different thicknesses between one end and the other end, and may have a functionality of preventing double image formation.

A manufacturing method for the film for laminating 600 may include a transferring operation to transfer the embossments to the film 600, thereby manufacturing the film for laminated glass 600 having an embossed surface. The transferring operation uses an embossment transferring device 100 including plural non-protrusions 10 and protrusions 20 surrounding the non-protrusions and being connected from one another, and the non-protrusions 10 has an average area of 4 mm² or less, and the protrusions 20 has an area of 0.05 mm² or less per unit area (1 cm^{2),}

Specifically, the non-protrusions 10 may have an average area of 2 mm² or less.

The average area may be 1 mm² or less. The average area may be 0.4 mm² or less. The average area may be 0.01 mm² or more. The average area may be 0.02 mm² or more. The average area may be 0.05 mm² or more.

The embossed surface includes plurality of convex parts 100 and plurality of concave parts 200 disposed between the plurality of convex parts neighboring to one another on some or the whole of one surface of the film.

The convex parts 100 may have a form surrounded by concave parts 200.

Before the transferring operation, an operation for manufacturing a film, which manufactures a film for laminating by applying a polymer resin and a plasticizer may be further included. Descriptions of the polymer resin and the plasticizer are overlapped with the above description, and thus the further description is omitted. Additionally, the operation for manufacturing a film for laminating may include any ordinary method for manufacturing a film, and for example, a co-extrusion method may be included.

The embossment transferring device 100 may have a roller form or a mold form, but the form is not limited thereto.

The transferring operation may proceed under a temperature condition of 30 to 150° C. When the transferring operation proceed at such a temperature, a film 600 having excellent deairing property and edge sealing property can be manufactured.

A process of designing the embossment transferring device 100 will be described.

On a reference plane having a certain size, a specific number of points corresponding to the number of convex parts desired to be formed, are formed. The points are arbitrarily generated without a regular pattern in the positions or the intervals, and when a distance between two points neighboring to each other is smaller than a predetermined value, the points are deleted, or when the distance is larger than a predetermined value, a point is added. Reference points arranged irregularly are formed in this manner (The formation process of reference points).

An outline (first outline), which is a vertical bisector line of a virtual line connecting two reference points neighboring to each other, is formed. At this time, the outline (first outline) is designed to be end at a point where the outline (first outline) meets another outline (second outline) formed between other two reference points (A process of deriving an outline).

When the outlines fill the reference plane, a certain thickness is given to the reference plane based on the outlines to form protrusions 20, and an embossment transferring device including an embossment pattern having plurality of non-protrusions 10 surrounded by the protrusions is manufactured (An operation for forming a transferring device).

The non-protrusions 10 may have an average area of 0.01 mm² to 4.00 mm². The average area may be 0.5 mm² or less. The non-protrusions 10 have a polygonal shape surrounded by protrusions 20, and a first protrusion has different shape or area from neighboring protrusions.

Surface characteristics of the embossment transferring device 100 are complementarily transferred to the film surface, and therefore the characteristics of an embossed surface can be controlled by controlling the surface characteristics of the embossment transferring device 100 (An operation for controlling surface characteristics).

Grit blast treatment can be made for etching the surface of the embossment transferring device 100. At this time, a condition (sizes of particles, a pressure of injection, a distance of injection, an angle of injection, and the like) applied during the grit blast treatment may be adjusted to control the surface characteristics, and this influences embossment characteristics of the film surface, complementarily.

For example, particles with an average diameter of 5 μm are injected to the surface of the embossment transferring device 100 with a direct pressure blast system at a distance of 20 cm to 30 cm and an injecting pressure of 0.4 MPa, and at this time, the angle of a nozzle is applied to be 90° to perform grit blast treatment. Through the grit blast treatment, a minute pattern can be formed on the surface of the embossment transferring device 100.

The embossment transferring device 100 is manufactured by a method described above, and after that, the device 100 transfers embossments on one surface of the film thereby forming the film for laminating 600 including convex parts 100 and concave parts 200.

The film for laminated glass 600 formed in this manner may form a laminated glass 900 by being stacked between a couple of glasses 700. The laminated glass 900 may be manufactured into the laminated glass by applying a pre-laminating process and a main laminating process in this order or at the same time.

Particularly, for the film for laminated glass 700 stacked between the couple of glasses 700 in the pre-laminating process, an air, which may be in a space between a glass and a film, can be removed by concave parts 200 inside an embossed surface, and because the embossments are irregular, diffraction interference fringes are inappreciable or not generated.

A light transmitting laminate according to another embodiment disclosed in the present disclosure includes a first light transmitting layer, a film for laminating disposed on one surface of the first light transmitting layer, and a second light transmitting layer disposed on the film for laminating.

The first light transmitting layer and the second light transmitting layer may be independently a light transmitting glass, or a light transmitting plastic, respectively.

The film for laminating is a film for laminating described above, and the detailed description thereof is overlapped with the above description, and thus the further description is omitted.

A vehicle according to another embodiment disclosed in the present disclosure includes a light transmitting laminate described above. The vehicle includes a body forming a main body of the vehicle, a driver (engine, etc.) attached to the body, a drive wheel rotatably attached to the body, a connector connecting the drive wheel and the driver; and a windshield attached to a part of the body, which is a light transmitting laminate for blocking wind from outside.

Hereinafter, detailed embodiments will be described in further detail. In below descriptions of experiments, a case where % is described without clarity whether the unit is wt % or mol %, refers to wt %.

### Manufacturing Example: Processing of Mold

### Manufacture of Pattern Mold Applying Regular Pattern

A pattern mold (MOLD#0) having a regular pattern in which embossments in a dot type shape are arranged in zigzags processed in a steel plate surface thereof is produced.

### Pattern Design of Embossment Shape and Manufacture of Pattern Mold

Points of 1.58 million are disposed irregularly on a unit plane of 45 cm width and length. A pattern is designed by drawing a line perpendicular to a virtual line connecting two points neighboring to one another, and by extending the line to a position meeting another arbitrary line.

In this method, irregularity means the distances of respective points are not even.

In detail, after points of 1.58 million are disposed arbitrarily on the unit plane, when the distance between points neighboring to each other is smaller than a predetermined value, the points were deleted, and when the distance is larger than a predetermined value, a point was added. Reference points arranged irregularly were generated through this method. The points formed in this manner allowed polygons of about 1.58 million to be drawn by the above-described method such as drawing a line perpendicular to a virtual line connecting two points neighboring each other, thereby completing a first pattern. The first pattern, in which line portions were convex and polygonal area portions were concave, was processed on the surface of a steel plate to manufacture a pattern mold (MOLD #1), and a depth of 40 μm and a width of about 50 μm were applied to the convex line portions. A shape of the manufactured pattern mold is shown in FIG. 3. Thereafter, transfer was performed after grit blast treatment on the surface of the pattern mold.

While a pattern was formed by the same method as above, points of about 810,000 were disposed irregularly on a unit plane of 45 cm width and length, to manufacture a pattern mold having a second pattern (MOLD #2), and points of about 400,000 were disposed on unit plane, to manufacture a pattern mold having a third pattern (MOLD #3).

When evaluated based on a pattern mold having a first pattern, it is identified that polygons of about 440 were included per unit area (1 cm²), and a shape of convex parts as lines enclosing polygons did not show a break or a nonuniform crossing point shape. The average area of non-protrusions of the pattern mold was about 0.2 mm² as observed.

When evaluated based on a pattern mold having a second pattern, it is identified that polygons of about 225 were included per unit area (1 cm²), and the shape of convex parts as lines enclosing polygons did not show a break or a nonuniform crossing point shape. The average area of non-protrusions of the pattern mold was about 0.4 mm² as observed.

When evaluated based on a pattern mold having a third pattern, it is identified that polygons of about 82 were included per unit area (1 cm²), and the shape of convex parts as lines enclosing polygons did not show a break or a nonuniform crossing point shape. The average area of non-protrusions of the pattern mold was about 1.2 mm² as observed.

### Manufacturing Example: Manufacture of Film

### Manufacture of Resin Composition and Additive

Respective ingredients used in the following Examples and Comparative Examples are described below.

Polyvinyl Butyral Resin (A): PVA and n-BAL having a polymerization degree of 1700 and a saponification degree of 99 were added to perform an ordinary synthesizing process, and thereby a polyvinyl butyral resin having a hydroxyl group of 20.3 wt %, a butyral group of 78.9 wt %, and an acetyl group of 0.8 wt % was obtained.

Manufacture of Additive: Irganox 1076 as an antioxidant of 0.1 parts by weight, TINUVIN-328 as a UV absorber of 0.2 parts by weight, Mg Acetate as an adhesion regulator of 0.03 parts by weight were blended and mixed in a tumbler to be sufficiently dispersed (A total amount of 0.33 parts by weight).

### Manufacture of Sheet

The polyvinyl butyral resin (A) of 72.67 wt %, 3g8 as a plasticizer of 27 wt % and an additive of 0.33 wt % were added to one twin-screw extruder and manufactured into a sheet of a mirror surface. In the manufacturing process, a PE (polyethylene) slip sheet was laminated to the sheet for preventing the sheets being attached to each other and winded to be a roll form. The manufactured sheet has a thickness of 760 μm and a width of 1.0 M.

### Manufacture of Samples

Example 1: The manufactured sheet was kept for 24 hours at 50° C. and 20 RH % (Relative Humidity %) to be aged, and further kept for 30 minutes at room temperature. The sheet after aging was cut to have a size of 300 mm width and length, after that the pattern mold MOLD #1 was disposed on both surfaces, and the sheet was placed in a laminator to be treated by patterning for 8 minutes under the condition of 120° C. and 1 atm. The sheet after the pattering was cooled to room temperature and a sample was obtained by uncovering the mold.

Example 2: While manufactured under the same condition as the manufacturing method of Example 1, Example 2 was manufactured by applying MOLD #2 as a pattern mold.

Example 3: While manufactured under the same condition as the manufacturing method of Example 1, Example 3 was manufactured by applying MOLD #3 as a pattern mold.

Comparative Example 1: While manufactured under the same condition as the manufacturing method of Example 1, Comparative Example 1 was manufactured by applying MOLD #0 was applied as a pattern mold.

### Evaluating Examples: Evaluation of Properties

### Measurement of 3D Roughness

Sz, Ssk, and A1 values of 3D roughness were respectively obtained from the film surface by a measuring device according to ISO_25178. Specifically, Contour GT model of 3D Optical Microscopy available from BRUKER was used to measure 3D roughness of a film at VSI (Vertical scanning Interferometry) Mode, and the above values were obtained.

The measurement was made by using a 2× ocular lens and a 5× objective lens. At this time, an area having a length of x axis of 0 to 0.887 mm and a length of y axis of 0 to 0.670 could be scanned. The measurement was repeated five times by designating a measuring area randomly in the same pattern, and three measured values except for the highest value and the lowest value were averaged and thereby a measuring value was obtained. The result was shown in below Table 1.

### Moire Evaluation

Manufacture of Samples for Evaluation) The manufactured sheet was cut to have a size of 1000 mm width and length, and aging thereof was performed by keeping the sheet for two days at 20° C. and 20 RH %. A sample film having a size of 300 mm width and length was sampled in a position of the center, a position of 10% from the right side of the sheet, and a position of 10% from the left side of the sheet, and total fifteen sample films were cut by the same method. After cutting the sample films, patterns were transferred on both surfaces of the samples under the same condition as the transferring condition of the Manufacture of Samples. For copying a manufacturing process for laminated glass, respective films were elongated within a range of 10% from the original length in wide and length, and applied to evaluation. The sample films were interposed respectively between two pieces of flat glasses having a thickness of 2.1 T (T=mm and the same as below), and after that kept for one hour at 20° C. to be manufactured into samples for evaluation. Fifteen samples were manufactured by Examples and by Comparative Examples, respectively, and a total number of the manufactured samples for evaluation was 60. The manufactured samples for evaluation were kept for one hour at 20° C.

Appearance Evaluation) The samples for evaluation were evaluated by naked eyes. A sample, in which a moire pattern was shown in the center or the edge of the sample for evaluation due to the surface pattern of the sample film was indicated. A total number of samples, in which a moire pattern was observed was checked by Examples and by Comparative Examples and shown in Table 1 below.

### Deairing Property Evaluation

Manufacture of Samples for Evaluation) The samples were laminated between circle type glass plates, and after that a vacuum ring was set. Thereafter, the samples were vacuumized by using a vacuum pump at room temperature. After the vacuumizing, the temperature was elevated by 10° C. and the variance of vacuum degree of sample films laminated between the circle type glass plate was measured.

Evaluating Method) When the variance of vacuum degree measured after the vacuumizing was performed and the temperature was elevated by 10° C. was more than 40 mmHg, it was expressed as X, when the variance of vacuum degree was more than 25 mmHg and 40 mmHg or less, it was expressed as A, when the variance of vacuum degree was more than 10 mmHg and 25 mmHg or less, it was expressed as ○, and when the variance of vacuum degree was 10 mmHg or less, it was expressed as ⊚ to be shown in below Table 1.

TABLE 1

| | The Condition for Surface Treatment | | | | | | | | | |
|---|---|---|---|---|---|---|---|---|---|---|
| | | The Number | Average | | | The Result of | | | | |
| | | of Convex | Area of | | | Measuring Surface | | | | |
| | | parts per | Convex | | | Roughness | | | The Number | Evaluation |
| | Pattern | Unit Area | parts | Temperature | Time | Sz | | | of Moire | of Deairing |
| Number | Mold | (1 cm²) | (mm²) | (° C.) | (Minute) | (um) | Ssk | A1 | Patterns | Property |
| Comparative | MOLD | — | — | 120 | 8 | 66.0 | 0.00 | 0.14 | 15 | ⊚ |
| Example 1 | #0 | | | | | | | | | |
| Example 1 | MOLD | 441 | 0.2 | 120 | 8 | 65.9 | 0.22 | 0.08 | 0 | ⊚ |
| | #1 | | | | | | | | | |
| Example2 | MOLD | 225 | 0.4 | 120 | 8 | 66.5 | −0.32 | 0.04 | 0 | ⊚ |
| | #2 | | | | | | | | | |
| Example 3 | MOLD | 82 | 1.2 | 120 | 8 | 66.7 | −1.39 | 0.00 | 0 | Δ |
| | #3 | | | | | | | | | |

According to the above Table 1, all Sz values of Examples and Comparative Examples were being distributed within a range of 65 to 67 μm as the result of measuring surface roughness. This may be considered as the results showing that the variation of Sz value is not large even though an embossment pattern, whose Ssk value and average area of convex parts were controlled, is transferred to the surface of the film for laminating.

While Comparative Example 1 was measured to have Ssk value of 0.00, Examples 1 to 3 applied with pattern molds MOLD #1 to MOLD #3, respectively, in which embossments are irregularly arranged, were measured to have absolute values of Ssk values within a range of 0.2 to 1.4. This means when a pattern mold MOLD #0 is applied, peak portions and valley portion of the film for laminating are symmetrically distributed, and when pattern molds MOLD #1 to MOLD #3 are applied, peak portions and valley portions of the film for laminating are asymmetrically distributed.

For A1 value, Comparative Example 1 was measured to have the value of 0.1 or more, but Examples 1 to 3 were measured to have the values of less than 0.1. This means when pattern molds MOLD #1 to MOLD #3 are applied, an upper end portion of the embossed surface is controlled to be maintained with less than a certain volume.

For moire pattern occurrence number, Examples 1 to 3 were observed not to have a moire pattern, but Comparative Example 1 was observed to have fifteen moire patterns. This is thought to occur because when a high symmetry was shown in peak portions and valley portions in an embossed surface of the film for laminating, it causes a moire pattern on the film surface more easily.

For deairing property evaluation, Example 1, Example 2, and Comparative Example 1 were measured to have a variance of vacuum degree of 10 mmHg or less, but Example 3 was measured to have a variance of vacuum degree of more than 25 mmHg and 40 mmHg or less. This is thought to occur because when the average area value of convex parts is a certain value or more on the surface of the film for laminating, it causes degradation of deairing property of the film for laminating.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A film for laminating comprising an embossed surface,
wherein the embossed surface comprises a plurality of convex parts and a plurality of concave parts disposed between the plurality of convex parts,
wherein each of the plurality of convex parts is surrounded by the plurality of concave parts and does not comprise a convex part,
wherein each of the plurality of convex parts has an average area of 4.0 mm² or less,
wherein an absolute value of Skewness (Ssk) of the embossed surface is more than 0, and 1 or less, and
wherein Ar of the embossed surface is 1.001 to 2, where Ar is calculated by the following Formula 1:
$$Ar = \frac{As}{Ac} \qquad [ Formula 1 ]$$
where, in the Formula 1, As is an average surface area of surface profiles of the plurality of convex parts comprised in a unit area (1 cm²) of the embossed surface and Ac is an average area occupied by the plurality of convex parts comprised in a unit area (1 cm²) of the embossed surface.

2. The film for laminating of claim 1, wherein the average area of the plurality of concave parts per unit area of 1 cm² is 0.5 mm² or less.

3. The film for laminating of claim 1, wherein the film for laminating has a variance of vacuum degree of 0 to 25 mmHg when, after light transmitting bodies are laminated on both surfaces thereof, vacuumizing is performed at room temperature and a temperature of the film for laminating is increased by 10° C.

4. The film for laminating of claim 1, wherein the embossed surface comprises a plurality of peak portions and a plurality of valley portions, and wherein the plurality of peak portions and the plurality of valley portions are asymmetrically distributed.

5. The film for laminating of claim 1, wherein the embossed surface has a ten-point height of irregularities (Sz) of 30 to 90 μm.

6. The film for laminating of claim 1, wherein at least one of the plurality of convex parts is enclosed by a closed curve formed by the at least one of the plurality of convex parts and the plurality of concave parts.

7. The film for laminating of claim 1, wherein the film for laminating further comprises a plurality of convex parts and a plurality of concave parts disposed between the plurality of convex parts disposed on at least some or all of another surface opposite to the embossed surface.

8. The film for laminating of claim 7, wherein shapes of the plurality of convex parts comprised in a unit area (1 cm²) of the embossed surface are different from shapes of the plurality of convex parts comprised in a unit area of the another surface.

9. The film for laminating of claim 1, wherein the embossed surface comprises 90 to 9,800 convex parts per unit area (1 cm²).

10. The film for laminating of claim 1, wherein the embossed surface comprises a minute pattern.

11. The film for laminating of claim 1, wherein each of the plurality of convex parts surrounded by the plurality of concave parts is adjacent to three to seven convex parts, which share some of the plurality of concave parts.

12. The film for laminating of claim 1, wherein the plurality of convex parts are different in shape.

13. The film for laminating of claim 1, wherein the film for laminating is a single layer or a laminated film of two or more layers.

14. The film for laminating of claim 1, wherein the film for laminating comprises a polyvinyl acetal resin.

15. The film for laminating of claim 1, wherein the film for laminating comprises a wedge shape in at least some or all of a cross-section thereof.

16. A light transmitting laminate comprising a first light transmitting layer, a film for laminating disposed on one surface of the first light transmitting layer, and a second light transmitting layer disposed on the film for laminating,
wherein the film for laminating comprises an embossed surface,
wherein the embossed surface comprises a plurality of convex parts and a plurality of concave parts disposed between plurality of convex parts,
wherein the plurality of convex parts are surrounded by the plurality of concave parts and do not comprise a concave part,
wherein each of the plurality of convex parts has an average area of 4.0 mm² or less,
wherein an absolute value of Skewness (Ssk) of the embossed surface is more than 0, and 1 or less, and
wherein Ar of the embossed surface is 1.001 to 2, where Ar is calculated by the following Formula 1:
$$Ar = \frac{As}{Ac} \qquad [ Formula 1 ]$$
where, in the Formula 1, As is an average surface area of surface profiles of the plurality of convex parts comprised in a unit area (1 cm²) of the embossed surface and Ac is an average area occupied by the plurality of convex parts comprised in a unit area (1 cm²) of the embossed surface.

17. A vehicle comprising the light transmitting laminate of claim 16.
